(19) United States
(12) Patent Application Publication
(10) Pub. No.: US 2026/0064333 A1
(43) Pub. Date: Mar. 5, 2026

(54) STORAGE MEDIUM, METHOD, AND INFORMATION PROCESSING APPARATUS

(71) Applicant: CANON KABUSHIKI KAISHA, Tokyo (JP)

(72) Inventor: YUICHI HASAMA, Chiba (JP)

(21) Appl. No.: 19/302,592

(22) Filed: Aug. 18, 2025

(30) Foreign Application Priority Data
Aug. 29, 2024 (JP) 2024-147301

(51) Int. Cl. G06F 3/12; G06F 21/64

(52) U.S. Cl. CPC G06F 3/1225; G06F 3/1222; G06F 21/64

(57) ABSTRACT

The present disclosure is directed to providing a technique for preventing a user from hesitating to install a driver due to a warning screen. A method of installing a driver set for controlling a peripheral device from an information processing apparatus onto the information processing apparatus includes determining whether a certificate corresponding to a digital signature included in a driver set for which an installation instruction has been received is present in the information processing apparatus and displaying a predetermined notification screen on a display unit in a case where it is determined that the certificate is not present in the information processing apparatus.

### BACKGROUND

### Field of the Technology

The present disclosure relates to a storage medium, a method, and an information processing apparatus.

### Description of the Related Art

A representative example of a print control program that controls a printer is a printer driver for Microsoft® Windows Operating System (hereinafter, referred to as Windows®).

The driver set of a printer driver for Windows® includes a catalog file (CAT file). A digital signature can be applied to the catalog file to prevent tampering with the driver, as described in Japanese Patent Laid-Open No. 2014-48956.

A digital signature is created by encrypting, with a private key, a hash value of the group of files that constitute the driver set. Decrypting a digital signature with a public key enables retrieval of the hash value, and comparing the retrieved hash value with the current hash value calculated from the driver set enables verification that the contents of each file in the driver set have not been altered.

There is an operating system (OS) that displays, in a case where a printer driver is installed in an information processing apparatus, a confirmation screen for confirming with the user whether to proceed with the installation depending on the issuer of the digital signature attached to the catalog file.

In the above-described conventional technique, even though the user executes an installer the user obtained, which indicates that the user's intent to install the driver is clear, a confirmation screen for confirming whether to proceed with the installation at the time of driver installation is displayed. This may lead the user to hesitate to install the driver upon the appearance of the confirmation screen, and in some cases, to instruct not to proceed with the installation.

### SUMMARY

According to an aspect of the present disclosure, a non-transitory computer readable storage medium stores a program for causing a computer of an information processing apparatus to execute a method of installing, onto the information processing apparatus, a driver set for controlling a peripheral device from the information processing apparatus. The method includes determining whether a certificate corresponding to a digital signature included in a driver set for which an installation instruction has been received is present in the information processing apparatus and displaying a predetermined notification screen on a display unit in a case where it is determined that the certificate is not present in the information processing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration according to an embodiment of the present disclosure.

FIG. 2 is a diagram illustrating a hardware configuration of a computer according to an embodiment of the present disclosure.

FIG. 3 is a diagram illustrating a software configuration of a computer according to an embodiment of the present disclosure.

FIG. 4 is a diagram illustrating a file structure of an installation set of a driver in a first embodiment of the present disclosure.

FIG. 5 is a diagram illustrating a transition of screens displayed by an installer according to the first embodiment of the present disclosure.

FIG. 6 is a diagram illustrating a security warning screen displayed by an operating system (OS) in the first embodiment of the present disclosure.

FIG. 7 is a diagram illustrating a process of an installer in the first embodiment of the present disclosure.

FIG. 8 is a diagram illustrating a screen displayed by an installer according to the first embodiment of the present disclosure.

FIG. 9 is a diagram illustrating a file structure of an installation set of a driver according to a second embodiment of the present disclosure.

FIG. 10 is a diagram illustrating a process of an installer according to the second embodiment of the present disclosure.

### DESCRIPTION OF THE EMBODIMENTS

Hereinafter, embodiments of the present disclosure will be described in detail with reference to the accompanying drawings. The following embodiments are not intended to limit the present disclosure, and not all combinations of features described in the embodiments are necessarily essential to the solution of the present disclosure.

The same components are denoted by the same reference numerals, and redundant descriptions thereof will be omitted.

### First Embodiment

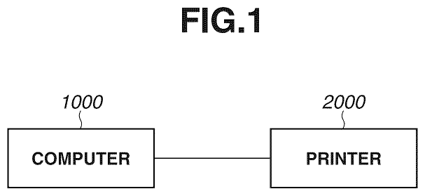

FIG. 1 illustrates a system configuration according to a first embodiment.

The system according to the present embodiment is a printing system, and includes a computer 1000, which is an example of an information processing apparatus, and a printer 2000, which is an example of a peripheral device. The information processing apparatus may be a smartphone. The peripheral device may be a scanner or a multifunction peripheral.

The computer 1000 and the printer 2000 are connected to each other via a network, a Universal Serial Bus (USB) port, or the like, enabling mutual communication.

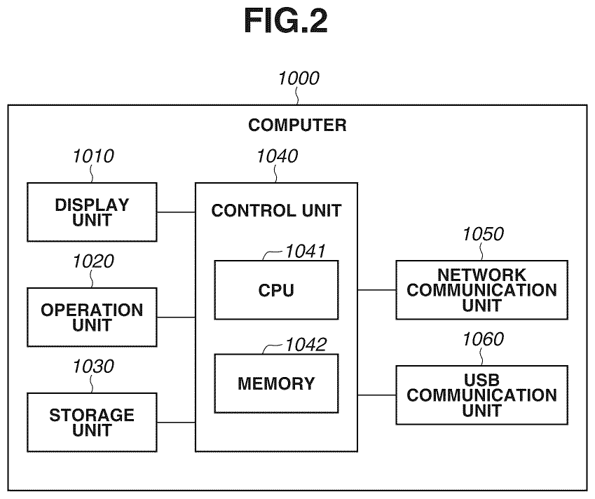

FIG. 2 is a block diagram illustrating a hardware configuration of the computer 1000.

The computer 1000 includes a CPU 1041, a memory 1042, a display unit 1011, an operation unit 1020, a storage unit 1030, a network communication unit 1050, and a USB communication unit 1060.

The CPU 1041 controls the computer 1000.

The memory 1042 includes, for example, a random access memory (RAM), and stores programs read by the CPU 1041. The CPU 1041 controls the computer 1000 by executing various programs stored in the memory 1042.

The display unit 1010 is an output device, such as a display.

The operation unit 1020 is an input device, such as a mouse, a keyboard, or a touch panel.

The storage unit 1030 is a storage medium, such as a hard disk or a solid state drive (SSD). The storage unit 1030 stores various types of software used by the computer 1000 to operate. An operating system (OS) 1110 and drivers (described below) are also stored in the storage unit 1030.

The network communication unit 1050 is connected to a network to input and output data to and from external devices.

The USB communication unit 1060 inputs and outputs data to and from external devices via USB connections. The computer 1000 and the printer 2000 are connected via the network communication unit 1050 or the USB communication unit 1060.

Software processing in the present embodiment is realized by reading software stored in the storage unit 1030 into the memory 1042 and executing the software.

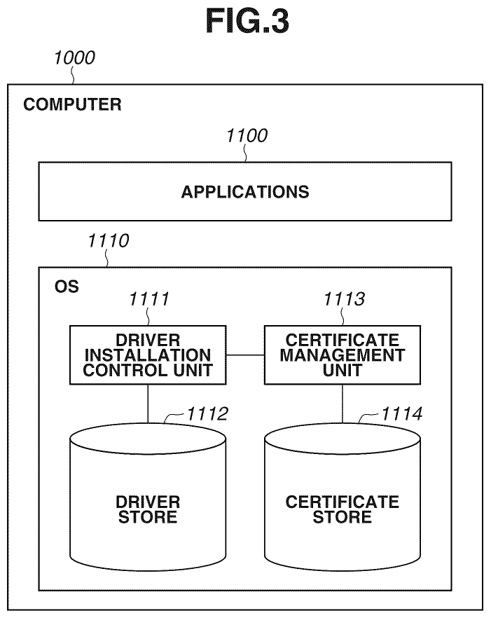

FIG. 3 is a diagram illustrating a software configuration of the computer 1000, which relates to the driver installation process according to the present embodiment.

The software of the computer 1000 is stored in the storage unit 1030.

Applications 1100 include various types of software, such as word processing software or spreadsheet software. An installer 1210 for a driver, which will be described below, is also one of the applications 1100.

The OS 1110 is software that controls the basic operations of the computer 1000. The OS 1110 includes a driver installation control unit 1111 and a certificate management unit 1113, and also includes a driver store 1112 and a certificate store 1114 as data areas.

The driver installation control unit 1111 controls installation of drivers, which are prepared external to the OS 1110, onto the OS 1110. Here, a driver refers to software for controlling a peripheral device, such as a printer 2000, from the computer 1000, and is generally provided by a vendor that manufactures the peripheral device. The installation of a driver onto the OS 1110 refers to the process of adding a driver provided by a vendor to the OS 1110 to enable the use of the peripheral device from the computer 1000 under the management of the OS 1110.

The driver installation control unit 1111 validates the driver to be installed and stores it in the driver store 1112. Thus, drivers for a wide variety of peripheral devices are stored in the driver store 1112.

The certificate management unit 1113 manages the certificates registered in the OS 1110.

The certificate store 1114 is managed by the certificate management unit 1113 and stores various types of certificates used by the OS 1110. Here, a certificate serves to verify the validity of a digital signature, and the relationship between the digital signature and the certificate is similar to a personal seal and a seal registration certificate. Certificates issued by the issuers that the administrator or user of the computer 1000 trusts are stored in the certificate store 1114.

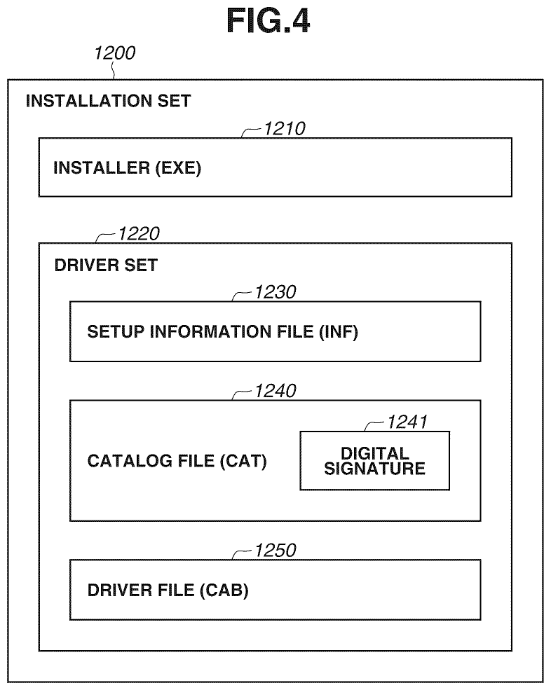

FIG. 4 is a diagram illustrating the file structure of a driver installation set 1200 according to the present embodiment.

The installation set 1200 is a set of files provided by the vendor of a peripheral device and includes files described below.

An installer (EXE) 1210 is an application 1100 for installing a driver, and is configured to install a driver file 1250 onto the OS 1110 when executed by a user with administrator privileges.

A driver set 1220 indicates a set of driver-related files before installation, and includes a setup information file (INF) 1230, a catalog file (CAT) 1240, and a driver file (CAB) 1250.

The setup information file (INF) 1230 includes information necessary for installing the driver file 1250. Specifically, the driver type and version, the file name of a catalog file 1240, the file name of the driver file 1250, the installation destination, and other types of information are included.

The catalog file (CAT) 1240 is used during installation of the driver file 1250 to verify the driver set 1220.

The catalog file (CAT) 1240 includes a digital signature 1241 and certificate of the driver file 1250, and is used to verify that the signed driver file 1250 has not been tampered with.

The driver file (CAB) 1250 is the main component of a driver to be installed, and is a compressed file containing executable programs, data files, and other components used to control the peripheral device.

A procedure for installing the driver for a peripheral device will now be described. In the present embodiment, an example in which the peripheral device is a printer will be described.

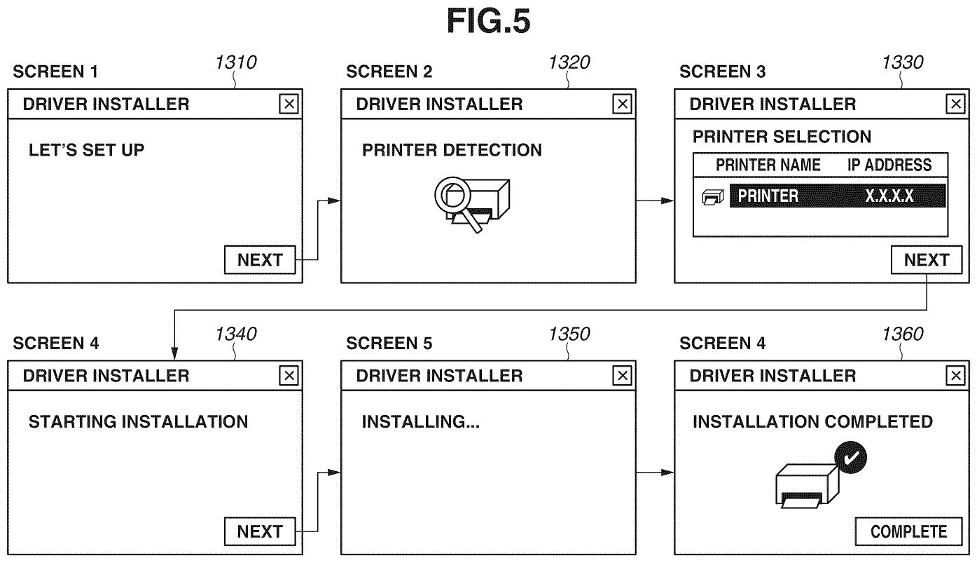

FIG. 5 is a diagram illustrating a transition of screens displayed on the display unit 1010 of the computer 1000 when the user launches the installer 1210 and the CPU 1041 executes the installer 1210. Here, an example in which a plurality of screens is displayed in a wizard format will be described.

A screen 1 (1310) is a screen that the CPU 1041 causes the display unit 1010 to display when the CPU 1041 executes the installer 1210 at the time of activation of the installer 1210. When the “Next” button is pressed via the operation unit 1020, the CPU 1041 displays a screen 2 (1320) on the display unit 1010.

While the screen 2 (1320) is being displayed, the CPU 1041 detects the printer(s) currently connected to the computer 1000. For example, the CPU 1041 detects the printer(s) currently connected to the computer 1000 via the network communication unit 1050 or the USB communication unit 1060. When the detection is completed, the CPU 1041 causes the display unit 1010 to display a screen 3 (1330).

A list of the printers detected during the display of the screen 2 (1320) is displayed on the screen 3 (1330). The user, on the screen 3 (1330), selects the driver for the printer to be installed via the operation unit 1020. When the “Next” button is pressed via the operation unit 1020 with any of the drivers displayed on the screen 3 (1330) selected, the CPU 1041 causes the display unit 1010 to display a screen 4 (1340).

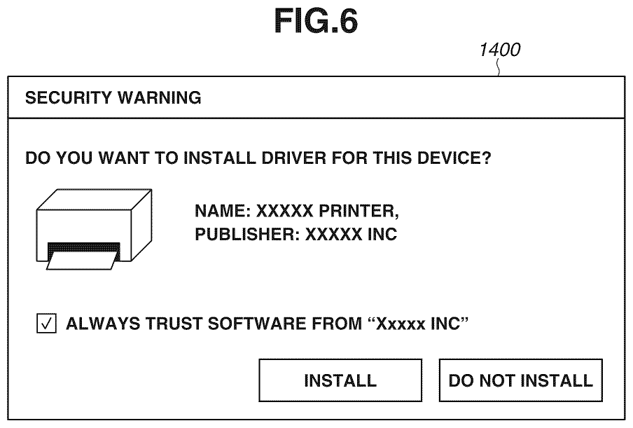

The screen 4 (1340) is a screen for notifying the user that the installation of the driver is to be started. When the “Next” button is pressed via the operation unit 1020, the CPU 1041 causes the display unit 1010 to display a screen 5 (1350) and starts installation of the driver. The driver installation is performed by the CPU 1041 executing the installer 1210 and calling the driver installation application programming interface (API) provided by the driver installation control unit 1111 of the OS 1110. The installer 1210 specifies a setup information file 1230 in the driver set 1220. Depending on the driver set 1220 to be installed, the OS 1110 may display a security warning screen. The security warning screen will be described below with reference to FIG. 6. Once the driver installation is completed, the CPU 1041 causes the display unit 1010 to display a screen 6 (1360) to notify the user that the installation has been completed. The processing then ends.

FIG. 6 is a diagram illustrating a security warning screen 1400 that the OS 1110 displays in driver installation in which the installer 1210 is displaying the screen 5 (1350).

When the driver installation API is called, the CPU 1041 executes the OS 1110 to obtain the filename of the catalog file 1240 in the specified setup information file 1230. The CPU 1041 then executes the OS 1110 to refer to the catalog file 1240 corresponding to the obtained filename, and identifies the certificate corresponding to the digital signature 1241 included in the catalog file 1240.

If the identified certificate is not present in the certificate store 1114 of the OS 1110, the CPU 1041 causes the display unit 1010 to display the security warning screen 1400.

The security warning screen 1400 displays information about the issuer of the digital signature 1241. The CPU 1041 receives an instruction from the user whether the driver with the digital signature 1241 of the issuer may be installed. When the “Install” button is pressed, the CPU 1041 starts installation of the specified driver by executing the OS 1110. When the “Do Not Install” button is pressed, the CPU 1041 cancels the installation of the driver.

The security warning screen 1400 also includes a checkbox enabling the user to select whether to always trust the drivers signed by the same issuer of the digital signature 1241. If the “Install” button is pressed with this setting selected (enabled), the CPU 1041 executes the OS 1110 to install the corresponding certificate into the certificate store 1114. Thus, the drivers signed with the same digital signature can be installed on subsequent installations without displaying the security warning screen 1400 during driver installation. If this setting is unselected (disabled) and the “Install” button is pressed, the CPU 1041 executes the OS 1110 to perform control as follows: the CPU 1041 causes the display unit 1010 to display the security warning screen 1400 again when installing the drivers with the same digital signature on subsequent installations.

Thus, displaying the security warning screen 1400 produces the beneficial effect of preventing the installation of drivers signed by suspicious issuers without the user's awareness.

Even when the user's intent to install a driver is explicit, a confirmation screen for confirming the installation is displayed at the time of driver installation. As a result, the user may find the fact that the confirmation screen is displayed suspicious, hesitate to proceed the installation, and ultimately issue an instruction not to install the driver.

In the present embodiment, the CPU 1041 performs control to prevent the user from hesitating to install a driver due to a warning screen. An example of the control will now be described.

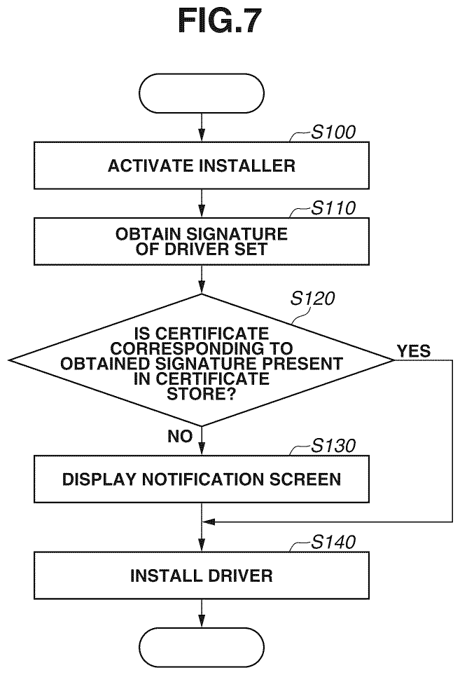

The process of installing a driver onto the OS 1110 by the CPU 1041 executing the installer 1210 will be described with reference to FIG. 7. The process illustrated in the flowchart in FIG. 7 is implemented by the CPU 1041 loading the installer 1210, stored in the storage unit 1030, into the memory 1042 and executing the installer 1210.

In step S100, in response to receiving an instruction to activate the installer 1210 from the user, the CPU 1041 activates the installer 1210. Here, the CPU 1041 causes the display unit 1010 to display the screen 1 (1310).

In step S110, the CPU 1041 executes the installer 1210 to obtain the digital signature 1241 from the catalog file 1240 in the driver set 1220.

In step S120, the CPU 1041 executes the installer 1210 to identify a certificate from the obtained digital signature 1241 and determine whether the certificate is present in the certificate store 1114. Specifically, the CPU 1041 executes the installer 1210 to obtain the serial number of the certificate included in the digital signature 1241, and checks whether any certificate with the same serial number is present in the certificate store 1114. If there is no certificate with the same serial number in certificate store 1114 (NO in step S120), the CPU 1041 advances the processing to step S130. If there is any certificate with the same serial number in the certificate store 1114 (YES in step S120), the CPU 1041 skips the operation in step S130 and advances the processing to step S140.

In step S130, the CPU 1041 executes the installer 1210 to cause the display unit 1010 to display a predetermined notice screen. Then, in step S140, the CPU 1041 executes the installer 1210 to install the driver in the OS 1110.

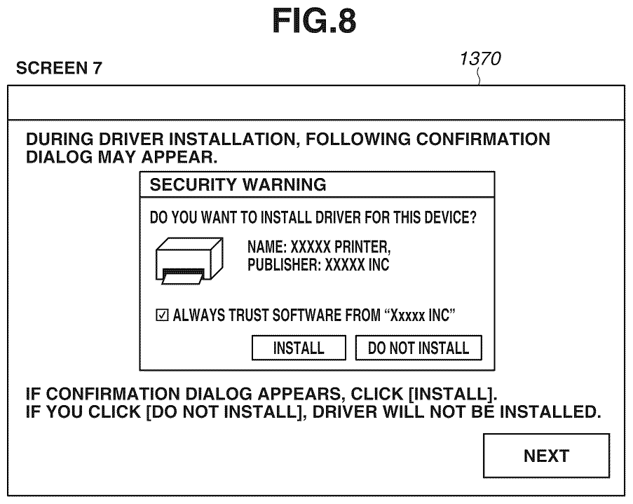

FIG. 8 is a diagram illustrating an example of a notification screen according to the present embodiment. In step S130, the CPU 1041 causes the display unit 1010 to display a screen 7 (1370) as the predetermined notice screen. The screen 7 (1370) displays a message indicating “During driver installation, the following confirmation dialog may appear”, where the confirmation dialog corresponds to the security warning screen 1400. The screen 7 (1370) also displays the confirmation dialog that appears midway through the wizard-format installation process as illustrated in FIG. 5. This enables the user to easily recognize what type of confirmation dialog will be displayed during the installation procedure, thus preventing the user from hesitating to install the driver during the installation. The screen 7 (1370) also displays an instruction stating: “If confirmation dialog appears, click “install”. If you click “do not install”, driver will not be installed”. This instruction enables the user to easily recognize the operation method after the confirmation dialog is displayed.

In the present embodiment, the CPU 1041 executes the installer 1210 to cause the display unit 1010 to display the screen 7 (1370) illustrated in FIG. 8 in between the screen 4 (1340) and the screen 5 (1350) illustrated in FIG. 5. In such a case, when the “Next” button in the screen 7 (1370) is pressed, the CPU 1041 executes the installer 1210 to cause the display unit 1010 to display the screen 5 (1350), and starts the driver installation.

The timing for causing the display unit 1010 to display the screen 7 (1370) illustrated in FIG. 8 may be set between any two screens, as long as it is before the display of the security warning screen 1400 illustrated in FIG. 6.

For example, when the “Next” button on the screen 1 (1310) is pressed via the operation unit 1020, the CPU 1041 may cause the display unit 1010 to display the screen 7 (1370). In such a case, when the “Next” button of the screen 7 (1370) is pressed via the operation unit 1020, the CPU 1041 causes the display unit 1010 to display the screen 2 (1320).

In another example, the CPU 1041 may cause the display unit 1010 to display the screen 7 (1370) in response to the detection of a printer during the display of the screen 2 (1320). In this case, when the “Next” button of the screen 7 (1370) is pressed via the operation unit 1020, the CPU 1041 causes the display unit 1010 to display the screen 3 (1330).

In still another example, when the “Next” button on the screen 3 (1330) is pressed via the operation unit 1020, the CPU 1041 may cause the display unit 1010 to display the screen 7 (1370). In this case, when the “Next” button on the screen 7 (1370) is pressed via the operation unit 1020, the CPU 1041 causes the display unit 1010 to display the screen 4 (1340).

As described above, in the present embodiment, displaying the notification screen presenting the screen 7 (1370) before display of the security warning screen 1400 prevents the user from hesitating to install a driver, thus improving user convenience.

### Second Embodiment

In the first embodiment, an example of a case where only one driver set is present in the driver installation set 1200 has been described.

In a second embodiment, an example case where a plurality of driver sets (3210 and 3260) is present in a driver installation set 3200 will be described.

The description of the processing equivalent to that in the first embodiment is omitted herein, and only differences will be described.

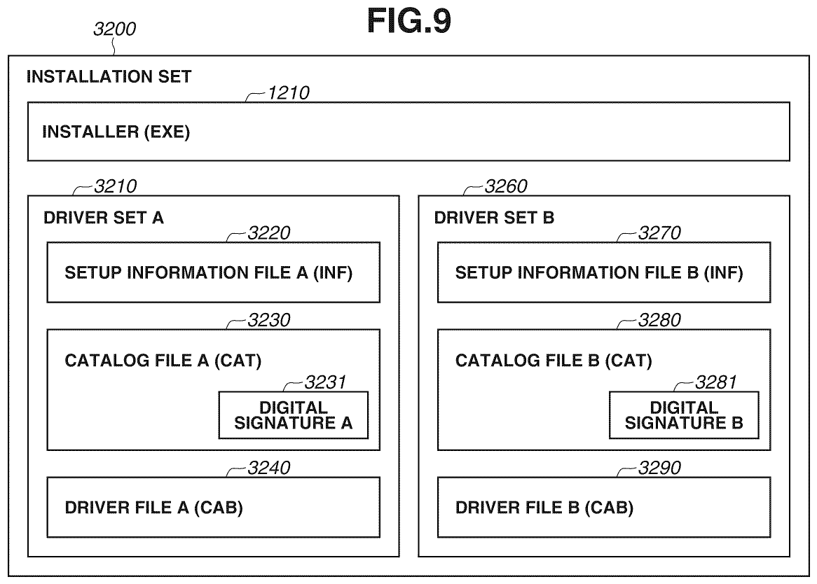

FIG. 9 is a diagram illustrating a file structure of the driver installation set 3200 in the second embodiment.

The driver installation set 3200 includes only one installer 1210, which is the same as in the configuration of the first embodiment.

A difference from the first embodiment is that the driver installation set 3200 in FIG. 9 contains two driver sets (3210, 3260). This applies to, for example, a printer driver and a scanner driver in a case where the peripheral device is a multifunction printer (multifunction peripheral). A multifunction printer has a plurality of functions, such as a print function and a scan function, in one device, and in some cases, separate drivers are prepared for each function. In such cases, a plurality of drivers can be installed using one installer 3210. The internal configurations of a driver set A 3210 and a driver set B 3260 are equivalent to that in the first embodiment. In the second embodiment, a catalog file A 3230 of the driver set A 3210 and a catalog file B 3280 of the driver set B 3260 are each assigned different digital signatures, namely a digital signature A 3231 and a digital signature B 3281, respectively.

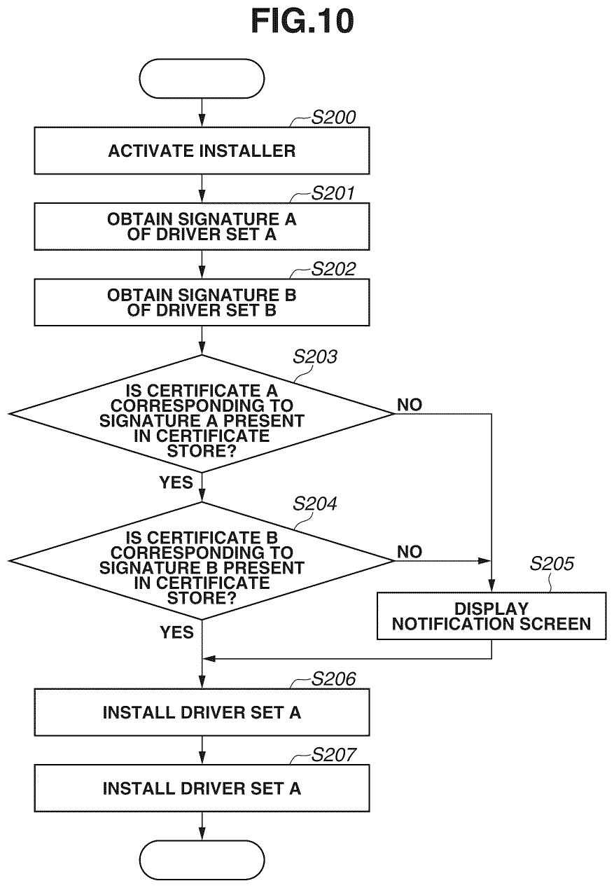

The process in which the installer 3210 installs a driver onto the OS 1110 in the second embodiment will be described with reference to FIG. 10, again focusing on the characteristic features of the present disclosure. The process illustrated in the flowchart of FIG. 10 is implemented by the CPU 1041 loading the installer 3210 stored in the storage unit 1030 into the memory 1042 and executing the installer 3210.

In step S201, the CPU 1041 receives an instruction to activate the installer 3210 from the user, and activates the installer 3210.

In step S201, the CPU 1041 executes the installer 3210 to obtain the digital signature A 3210 from the catalog file A 3230 in the driver set A 3231. The method of obtaining the signature is similar to that in the first embodiment, and thus a detailed description thereof is omitted herein.

In step S202, the CPU 1041 executes the installer 3210 to obtain the digital signature B 3281 from the catalog file B 3280 of the driver set B 3260. The method of obtaining the signature is similar to that in the first embodiment, and thus a detailed description thereof is omitted herein.

In step S203, the CPU 1041 executes the installer 3210 to identify a certificate A from the digital signature A 3231 obtained in step S201, and determines whether any certificate that corresponds to the certificate A is present in the certificate store 1114. If the CPU 1041 determines that the certificate corresponding to the certificate A is present in the certificate store 1114 (YES in step S203), the CPU 1041 advances the processing to step S204. If the CPU 1041 determines that the certificate corresponding to the certificate A is not present in the certificate store 1114 (NO in step S203), the CPU 1041 advances the processing to step S205.

In step S204, the CPU 1041 executes the installer 3210 to identify a certificate B also from the digital signature B 3281 obtained in step S202, and determines whether any certificate that corresponds to the certificate B is present in the certificate store 1114. If the CPU 1041 determines that the certificate corresponding to the certificate B is present in the certificate store 1114 (YES in step S204), the CPU 1041 advances the processing to step S206. If the CPU 1041 determines that the certificate corresponding to the certificate B is not present in the certificate store 1114 (NO in step S204), the CPU 1041 advances the processing to step S205.

In step S205, the CPU 1041 executes the installer 3210 to cause the display unit 1010 to display a notice screen, such as the screen 7 (1370) illustrated in FIG. 8. In the second embodiment, the CPU 1041 executes the installer 1210 to cause the display unit 1010 to display the screen 7 (1370) illustrated in FIG. 8 in between the screen 4 (1340) and the screen 5 (1350) illustrated in FIG. 5. In such a case, when the “Next” button on the screen 7 (1370) is pressed, the CPU 1041 executes the installer 1210 to cause the display unit 1010 to display the screen 5 (1350), and starts the driver installation.

The timing for causing the display unit 1010 to display the screen 7 (1370) illustrated in FIG. 8 may be set between any two screens, as long as it is before the display of the security warning screen 1400 illustrated in FIG. 6.

For example, when the “Next” button of the screen 1 (1310) is pressed via the operation unit 1020, the CPU 1041 may cause the display unit 1010 to display the screen 7 (1370). In such a case, when the “Next” button on the screen 7 (1370) is pressed via the operation unit 1020, the CPU 1041 cause the display unit 1010 to display the screen 2 (1320).

In another example, the CPU 1041 may cause the display unit 1010 to display the screen 7 (1370) in response to the detection of a printer during the display of the screen 2 (1320). In this case, when the “Next” button on the screen 7 (1370) is pressed via the operation unit 1020, the CPU 1041 causes the display unit 1010 to display the screen 3 (1330).

In still another example, when the “Next” button on the screen 3 (1330) is pressed via the operation unit 1020, the CPU 1041 may cause the display unit 1010 to display the screen 7 (1370). In this case, when the “Next” button on the screen 7 (1370) is pressed via the operation unit 1020, the CPU 1041 causes the display unit 1010 to display the screen 4 (1340).

In step S206, the CPU 1041 installs the driver set A onto the OS 1110 by executing the installer 3210. In step S207, the CPU 1041 installs the driver set B onto the OS 1110 by executing the installer 3210.

As described above, in the second embodiment, the processing of the installer 3210, which targets the installation of a plurality of drivers, has been described.

According to the second embodiment, similar beneficial effects can be achieved even in installing a plurality of driver sets (3210, 3260). In particular, displaying of a notification screen, such as the screen 7 (1370) in FIG. 8, only once can prevent repeated displays of the notification screen for each of the plurality of drivers. In other words, as many times as the number of drivers, thus mitigating reduction in user convenience.

While embodiments of the present disclosure have been described above, the present disclosure is not limited to these embodiments, and various modifications and changes can be made within the scope of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-147301, filed Aug. 29, 2024, which is hereby incorporated by reference herein in its entirety.

What is claimed is:

1. A non-transitory computer readable storage medium storing a program for causing a computer of an information processing apparatus to execute a method of installing, onto the information processing apparatus, a driver set for controlling a peripheral device from the information processing apparatus, the method comprising:
determining whether a certificate corresponding to a digital signature included in a driver set for which an installation instruction has been received is present in the information processing apparatus; and
displaying a predetermined notification screen on a display unit in a case where it is determined that the certificate is not present in the information processing apparatus.

2. The non-transitory computer readable storage medium according to claim 1, wherein the predetermined notification screen is a notification screen for notifying that a warning screen is to be displayed during the installation.

3. The non-transitory computer readable storage medium according to claim 1, wherein the computer is further caused to execute an installation process of installing the driver set for which the installation instruction has been received onto the information processing apparatus after the predetermined notification screen is displayed.

4. The non-transitory computer readable storage medium according to claim 1, wherein the computer is further caused to execute a process for displaying, on the display unit, a plurality of screens indicating a procedure for installing the driver set for which the installation instruction has been received in a wizard format.

5. The non-transitory computer readable storage medium according to claim 4,
wherein the plurality of screens includes a screen indicating that a driver is being installed, and
wherein the predetermined notification screen is displayed before the screen indicating that a driver is being installed.

6. The non-transitory computer readable storage medium according to claim 5, wherein the predetermined notification screen is displayed in a wizard format.

7. The non-transitory computer readable storage medium according to claim 1, the method further comprising:
determining whether a first certificate corresponding to a digital signature included in a first driver set for which an installation instruction has been received is present in the information processing apparatus; and
determining whether a second certificate corresponding to a digital signature included in a second driver set for which an installation instruction has been received is present in the information processing apparatus;
wherein, the predetermined notification screen is displayed on the display unit in a case where it is determined that the first certificate or the second certificate is absent in the information processing apparatus.

8. The non-transitory computer readable storage medium according to claim 7, wherein, in a case where it is determined that the first certificate or the second certificate is absent in the information processing apparatus, the predetermined notification screen is displayed once on the display unit.

9. The non-transitory computer readable storage medium according to claim 1, wherein the peripheral device is a printer.

10. The non-transitory computer readable storage medium according to claim 1, wherein the peripheral device is a multifunction peripheral.

11. A method of installing a driver set for controlling a peripheral device from an information processing apparatus onto the information processing apparatus, the method comprising:
determining whether a certificate corresponding to a digital signature included in a driver set for which an installation instruction has been received is present in the information processing apparatus; and
displaying a predetermined notification screen on a display unit in a case where it is determined that the certificate is not present in the information processing apparatus.

12. An information processing apparatus, comprising:
at least one memory storing a program; and
at least one processor, that when executing the program, causes the information processing apparatus to:
determine whether a certificate corresponding to a digital signature included in a driver set for which an installation instruction has been received is present in the information processing apparatus, and
display a predetermined notification screen in a case where it is determined that the certificate is not present in the information processing apparatus.
